(19) United States
(12) Patent Application Publication
(10) Pub. No.: US 2016/0016396 A1
(43) Pub. Date: Jan. 21, 2016

(54) METHOD OF MANUFACTURING LAYERED PANEL AND METHOD OF CHECKING STATE OF CURE OF THE LAYERED PANEL

(71) Applicant: SHARP KABUSHIKI KAISHA, Osaka-shi, Osaka (JP)

(72) Inventors: Ryoh KIKUCHI, Osaka-shi (JP); Kenichiroh TSUCHIDA, Osaka-shi (JP)

(21) Appl. No.: 14/772,547

(22) PCT Filed: Feb. 21, 2014
(86) PCT No.: PCT/JP2014/054114

§ 371 Date: Sep. 3, 2015

(30) Foreign Application Priority Data
Mar. 21, 2013 (JP) 2013-058564

(51) Int. Cl. B32B 38/00; B32B 38/10

(52) U.S. Cl. CPC B32B 38/0008; B32B 38/10; B32B 2310/00; B32B 2307/40

(57) ABSTRACT

A method of manufacturing a layered panel 16 includes steps of: performing a first attaching process to attach an adhesive sheet to a first panel member 110, the first panel member 110 including a panel 11 and a frame-shaped light blocking portion 14, the adhesive sheet 15 being made of ultraviolet curing adhesive and including a main body 15a and a test portion, the main body 15a being for covering a portion of a surface of the first panel member 110 that is on an inner side with respect to the light blocking portion 14, the test portion 15b extending outward from a periphery of the main body 15a and to be on the light blocking portion 14; performing a second attaching process to attach a surface of a second panel member 12 to another surface of the uncured adhesive sheet 15 such that the test portion 15b is projected outward from a periphery of the second panel member 12; applying ultraviolet rays to the adhesive sheet 15; peeling the test portion 15b from the light blocking portion 14; and checking a cure state of the adhesive sheet 15 based on a state of the test portion 15b in the peeling step.

### TECHNICAL FIELD

The present invention relates to a method of manufacturing a layered panel and a method of checking a state of cure of the layered panel.

### BACKGROUND ART

A liquid crystal display device such as a mobile information terminal that includes a liquid crystal display panel has been known. Such a liquid crystal display device includes a transparent protection panel (a cover panel) for protecting a surface of the liquid crystal display panel. In a conventional configuration, the protection panel is fixed at an upper portion of a box-like casing that holds the liquid crystal display panel therein. In recent years, to reduce the thickness of the liquid crystal display device, the protection panel is directly bonded to a front surface (a display surface) of the liquid crystal display panel by adhesive, as described in Patent document 1.

The adhesive for bonding the liquid crystal display panel to the protection panel may be an adhesive made of an ultraviolet curing resin (hereinafter, an ultraviolet curing adhesive), as disclosed in Patent document 1.

The ultraviolet curing adhesive that is in an uncured state is applied to a surface of the liquid crystal display panel or a surface of the protection panel. The liquid crystal display panel and the protection panel are bonded such that the applied ultraviolet curing adhesive in the uncured state is sandwiched therebetween. Ultraviolet rays are applied to the ultraviolet curing adhesive that is sandwiched between the liquid crystal display panel and the protection panel and thus the adhesive is completely cured.

Patent document 2 and Patent document 3 each describe a technology to bond substrates of a liquid crystal display panel with a sealing resin that is used to seal liquid crystals in between the substrates. The sealing resin is an ultraviolet curing resin. The sealing resin includes a colorant. The color of the colorant changes when ultraviolet rays are applied to the colorant. Therefore, by visually observing whether the color of the colorant has changed, a state of cure of the sealing resin can be checked.

### RELATED ART DOCUMENT

### Patent Document

Patent Document 1: Japanese Unexamined Patent Application Publication No. 2011-158851

Patent Document 2: Japanese Unexamined Patent Application Publication No. H11-109382

Patent Document 3: Japanese Unexamined Patent Application Publication No. 2000-330122

### Problem to be Solved by the Invention

If the ultraviolet curing adhesive between the protection panel and the liquid crystal display device is not properly cured, positions of the protection panel and the liquid crystal display panel may be displaced or the protection panel or the liquid crystal display panel may be removed from the ultraviolet curing adhesive. To properly grasp the presence of such problems, it may be necessary to check the state of cure of the ultraviolet curing adhesive sandwiched between the protection panel and the liquid crystal display panel after ultraviolet rays are applied as described before.

As one of conventional methods to check the state of cure of the ultraviolet curing adhesive between the protection panel and the liquid crystal display panel, a destructive test is performed in which the protection panel is removed from the liquid crystal panel. The destructive test cannot be performed on the factory floor and thus the state of cure of the ultraviolet curing adhesive between the panels is not immediately checked. Furthermore, the panel examined by the destructive test cannot be used as a component of a liquid crystal display device.

As described in Patent documents 2 and 3, a colorant may be mixed with the ultraviolet curing adhesive. The colorant changes its color when irradiated with ultraviolet rays. Accordingly, the state of cure may be checked according to a change in color before and after ultraviolet irradiation. The ultraviolet curing adhesive is applied between the protection panel and the liquid crystal display panel to cover the display surface of the liquid crystal display panel and therefore, if the colorant is mixed with the ultraviolet curing adhesive, quality of images in the liquid crystal display device may be degraded.

### Disclosure of the Present Invention

The present invention is to provide a technology for easily checking a state of cure of an ultraviolet curing adhesive in production of a layered panel including panel members bonded with the ultraviolet curing adhesive sandwiched therebetween.

### Means for Solving the Problem

To resolve the above problems, the method of manufacturing the layered panel 16 includes a first attachment process, a second attachment process, an applying process, a peeling process, and a checking process. In the first attachment process, an adhesive sheet is attached to a first panel member through which rays of light pass and a light blocking portion blocking rays of light and having a frame-like shape and located on a peripheral edge portion of one plate surface of the panel. The adhesive sheet is a transparent sheet made of ultraviolet curing adhesive and configured to cure when ultraviolet rays are applied. The adhesive sheet includes a main body and a test portion. The main body is for covering a portion of the one plate surface of the first panel member that is on an inner side with respect to the light blocking portion. The test portion extends outward from the periphery of the main body and disposed on the light blocking portion. In the first attachment process, one of surfaces of the adhesive sheet is attached to the one surface of the panel of the first panel member with adhesive in an uncured state. In the second attachment process, one of the plate surfaces of a second panel member is attached to another one of the surfaces of the adhesive sheet in the uncured state such that the test portion is projected outward from a periphery of the second panel member, and such that the main body is sandwiched between the second panel member and the first panel member. In the applying process, ultraviolet rays are applied to the adhesive sheet that is sandwiched between the first panel member and the second panel member. In the peeling process, the test portion is peeled from the light blocking portion while being separated from the main body. In the checking process, a state of cure of the adhesive sheet is checked based on a state of the test portion while the test portion is being peeled. According to the method of manufacturing the layered panel, in the checking process, the state of cure of the adhesive sheet is easily checked based on the state of the test portion while the test portion is being peeled.

In the method of manufacturing a layered panel, the peeling process may include measuring a peeling force of the test portion while the test portion is being peeled, and the checking process may include checking the state of cure of the adhesive sheet based on a result of the measuring of the peeling force of the test portion. According to the manufacturing method of the layered panel, the state of the test portion while the test portion is being peeled is qualitatively grasped from the peeling force measured in the peeling process. Therefore, the state of cure of the adhesive sheet is accurately checked.

In the method of manufacturing the layered panel, the adhesive sheet may include a separation line along a border between the main portion and the test portion. The separation line may be configured to assist separation of the test portion from the main body. In the peeling step, the test portion may be separated from the main body along the separation line. In the method of manufacturing the layered panel, the test portion is properly separated from the main body. That is, the main body is less likely to crack while the test portion is being peeled and thus the main body is less likely to be damaged. Furthermore, the test portion is less likely to be separated from the main body such that a portion of the test portion remains with the main body. Thus, peeling failure is less likely to occur.

In the method of manufacturing the layered panel, the test portion may include a continuing portion and an outer portion. The continuing portion may be continuous with the main body. The outer portion is outward with respect to the continuing portion. The continuing portion is narrower than the outer portion. According to the method of manufacturing the layered panel, the test portion is easily removed from the main body.

In the method of manufacturing the layered panel, the test portion may include no less than two test portions. According to the method of manufacturing the layered panel, the peeling process can be performed multiple times (more than two times). If the state of cure is judged as insufficient in the checking process after the peeling step, the peeling process and the checking process are repeated after applying the ultraviolet rays and thus the state of cure can be grasped. Furthermore, based on the peeling step performed multiple times, the state of cure of the adhesive sheet can be accurately grasped.

In the method of manufacturing the layered panel, the second panel member may be a liquid crystal display panel.

In the method of manufacturing the layered panel, the second panel member may be a touch panel.

A method of checking a state of cure of an adhesive sheet of a layered panel, the layered panel including includes a first panel member, a second panel member, and an adhesive sheet, and the method includes a peeling process and a checking process. The first panel member includes a panel through which rays of light pass and a light blocking portion for blocking rays of light. The light blocking portion is a layer having a frame-like shape, and located on a peripheral portion of one of plate surfaces of the panel. The adhesive sheet is a transparent sheet made of ultraviolet curing adhesive and configured to cure when ultraviolet rays are applied. The adhesive sheet covers a portion of the one of the plate surfaces of the first panel member. The adhesive sheet is sandwiched between the first panel member and the second panel member for attaching the first panel member and the second panel member. The method includes a peeling step and a checking step. The adhesive sheet includes a main body and a test portion. The main body covers the portion of the one of the plate surfaces of the first panel member that is on an inner side with respect to the light blocking portion. The test portion extends outward from a periphery of the main body and is on the light blocking portion such that the test portion is projected outward from a periphery of the second panel member. The peeling process includes peeling the test portion from the light blocking portion while separating the test portion from the main body. In the checking process, the state of cure of the adhesive sheet is checked based on a state of the adhesive sheet in the peeling process.

In the method of checking a state of cure, when the test portion is being peeled, a peeling force of the test portion may be measured. Based on a result of the measurement of the peeling force of the test portion, the state of cure of the adhesive sheet may be accurately checked. According to the method of checking the state of cure, the state of the test portion is qualitatively grasped by measuring the peeling force of the test portion while the test portion is being peeled. Therefore, the state of cure of the adhesive sheet is accurately checked.

In the method of checking the state of cure, the adhesive sheet may include a separation line in a border between the main body and the test portion. The separation line may be configured to assist separation of the test portion from the main body. The test portion may be peeled from the light blocking portion while being separated from the main body along the separation line. In the method of checking the layered panel, the test portion is properly separated from the main body. That is, the main body is less likely to crack while the test portion is being peeled. Thus, the main body is less likely to be damaged. Furthermore, the test portion is less likely to be separated from the main body such that a portion of the test portion remains with the main body. Thus, peeling failure is less likely to occur.

### Advantageous Effect of the Invention

The present invention provides a technology of easily checking a state of cure of an ultraviolet curing adhesive in production of a layered panel including panels bonded with the ultraviolet curing adhesive sandwiched therebetween.

### BRIEF DESCRIPTION OF THE DRAWINGS

FIG. 1 is a perspective view of a liquid crystal display device according to a first embodiment.

FIG. 2 is a rear plan view of a cover panel.

FIG. 3 is a plan view of an ultraviolet curing adhesive sheet.

FIG. 4 is an explanatory view of the ultraviolet curing adhesive sheet attached to the cover panel.

FIG. 5 is a plan view of a layered panel in which a liquid crystal display panel is attached to the ultraviolet curing adhesive sheet illustrated in FIG. 4.

FIG. 6 is a cross-sectional view of line A-A′ in FIG. 5.

FIG. 7 is a cross-sectional view of the layered panel after an autoclave process is performed.

FIG. 8 is an explanatory view of the layered panel illustrating a process of applying ultraviolet rays to the layered panel for curing the ultraviolet curing adhesive sheet.

FIG. 9 is an explanatory view of the layered panel illustrating how a peeling test is performed.

FIG. 10 is a plan view of a layered panel according to a second embodiment.

FIG. 11 is a plan view of a layered panel according to a third embodiment.

FIG. 12 is a plan view of a layered panel according to a fourth embodiment.

FIG. 13 is a plan view of a layered panel according to a fifth embodiment.

### MODE FOR CARRYING OUT THE INVENTION

### First Embodiment

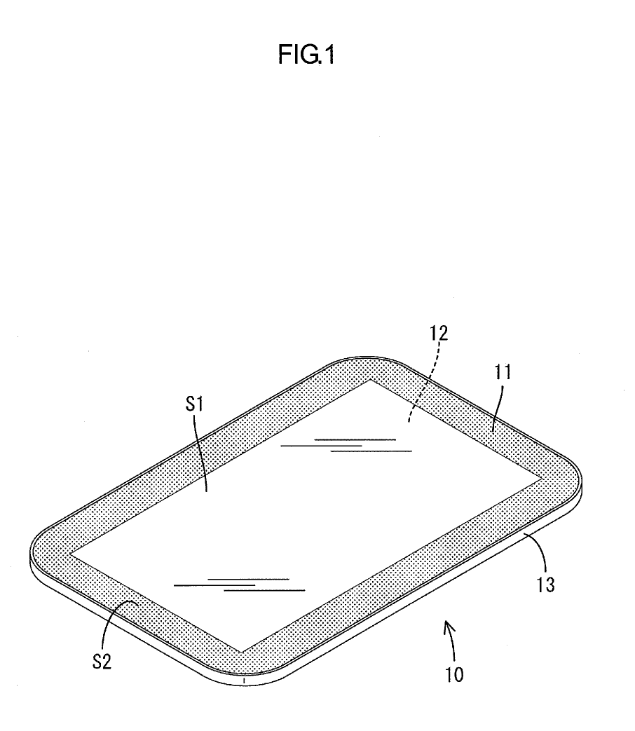

A first embodiment will be described with reference to FIGS. 1 to 9. A method of manufacturing a layered panel included in a liquid crystal display device and a method of checking a state of cure of the layered panel will be described.

FIG. 1 is a perspective view of a liquid crystal display device 10 according to the first embodiment. As illustrated in FIG. 1, the liquid crystal display device 10 has a substantially rectangular and vertically long overall shape (rectangle). The liquid crystal display device 10 includes a transparent cover panel 11 and a liquid crystal display panel (an example of a second panel member) 12. A front surface of the liquid crystal panel 12 (a display surface) is covered with the cover panel 11. The cover panel 11 and the liquid crystal display panel 12 are bonded with an ultraviolet curing adhesive sheet, which will be described later. Components of the liquid crystal display device 10 such as the cover panel 11 and the liquid crystal display panel 12 are arranged in a casing 13. The casing 13 has a shallow tray-like shape and has an opening at a top thereof. The casing is made of synthetic resin or metal.

In this description, the panels bonded by the ultraviolet curing adhesive sheet sandwiched therebetween (e.g., the cover panel 11 and the liquid crystal display panel 12) will be referred to as a layered panel.

As illustrated in FIG. 1, the cover panel 11 is a transparent plate made of glass or transparent resin such as acrylic resin. The cover panel 11 has a substantially rectangular and vertically long shape. Four corners of a periphery of the cover panel 11 are chamfered into a rounded (curved) shape. The cover panel 11 is a component for protecting the liquid crystal display panel 12 and arranged so as to cover an entire area of the display surface of the liquid crystal display panel 12. When images are displayed on the display surface of the liquid crystal display panel 12, a user of the liquid crystal display device 10 recognizes the images through the cover panel 11. A middle region of the cover panel 11 is a rectangular transparent region S1 through which light passes and images are displayed thereon. A peripheral region of the cover panel 11 around the transparent region S1 is a non-transparent region S2 having a frame-like shape. Light does not pass through the non-transparent region S2 and images are not displayed on the non-transparent region S2. Examples of the light that passes through the transparent region S1 but does not pass through the non-transparent region S2 are visible light and ultraviolet light.

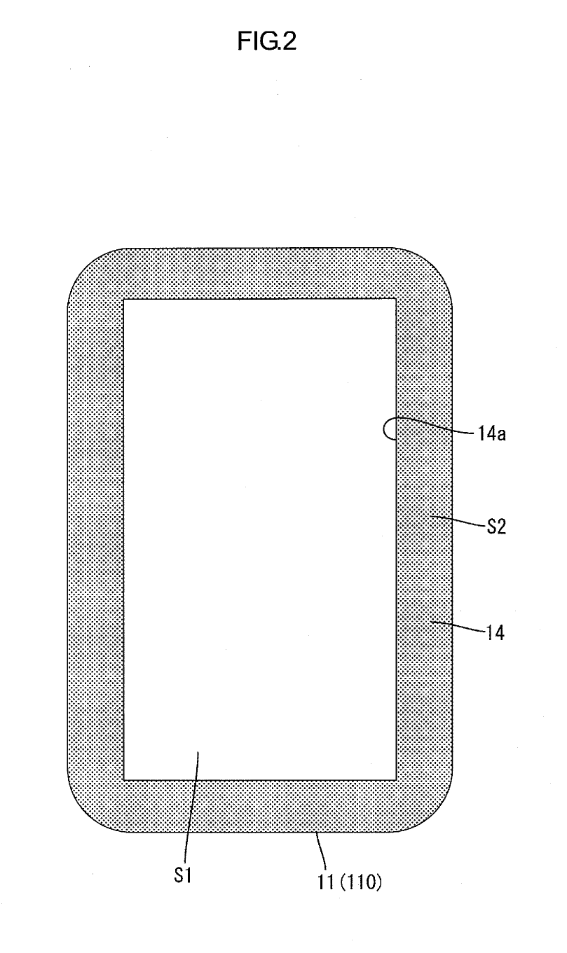

FIG. 2 is a rear plan view of the cover panel 11. As illustrated in FIG. 2, the cover panel 11 includes a light blocking portion 14 on a peripheral portion of a rear surface of the cover panel 11 for blocking light. The light blocking portion 14 is a layer (a film) formed with black ink on the rear surface of the cover panel 11 using printing methods such as screen printing and inkjet printing. As illustrated in FIG. 2, the light blocking portion 14 has an overall frame-like shape and is configured as the non-transparent region S2. A portion of the rear surface of the cover panel 11 is uncovered inside the frame-like non-transparent region S2 and the uncovered portion is the transparent region S1. The cover panel 11 including the light blocking portion 14 on the rear surface thereof is a first panel member 110 according to this embodiment.

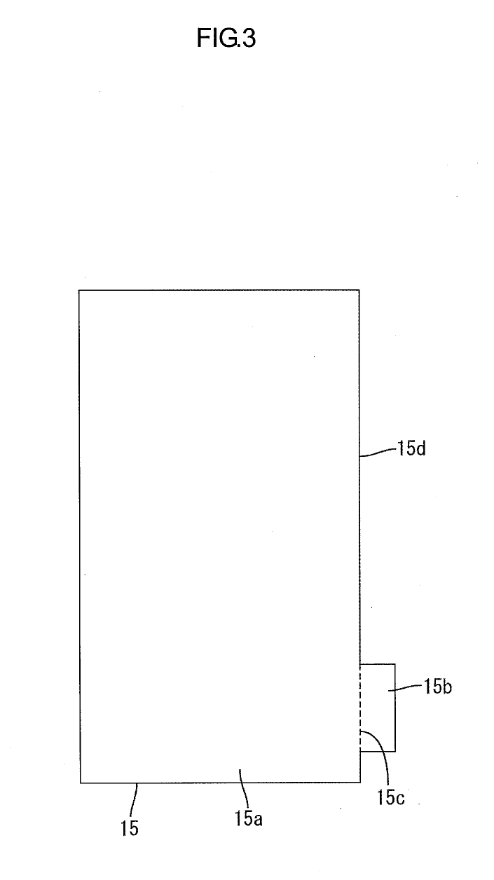

FIG. 3 is a plan view of the ultraviolet curing adhesive sheet 15. The ultraviolet curing adhesive sheet (an example of an adhesive sheet) 15 is a double-sided and transparent adhesive sheet used to bond the cover panel 11 and the liquid crystal display panel 12. The ultraviolet curing adhesive sheet 15 is an ultraviolet curing adhesive that is in a state not fully cured (hereinafter referred to as an uncured state) and formed into a sheet-like shape. When the ultraviolet curing adhesive sheet 15 is exposed to ultraviolet rays, a curing reaction, such as a crosslinking reaction, develops and thus the ultraviolet curing adhesive sheet 15 cures. Accordingly, adhesive force of the ultraviolet curing adhesive sheet 15 adheres to adherends increases. The ultraviolet curing adhesive sheet 15 may be called as an optical clear adhesive (OCA) and may have a thickness about 175 μm.

A front surface and a rear surface of the ultraviolet curing adhesive sheet 15 are adhesive surfaces that are to be attached to the respective adherends. The adhesive surfaces of the ultraviolet curing adhesive sheet 15 before attached to the adherends (i.e., before use) are protected with release liners. The release liners are appropriately removed from the respective adhesive surfaces of the ultraviolet curing adhesive sheet 15 before the ultraviolet curing adhesive sheet 15 is attached to the adherends.

The ultraviolet curing adhesive sheet 15 in the uncured state has rigidity (hardness) which is sufficient to maintain the shape (sheet-like shape) of the ultraviolet curing adhesive sheet 15. Furthermore, the ultraviolet curing adhesive sheet 15 has thermal flexibility at least in the uncured state. Thus, the ultraviolet curing adhesive sheet 15 softens when heated.

As illustrated in FIG. 3, the ultraviolet curing adhesive sheet 15 has a rectangular and vertically long overall shape, similar to the cover panel 11. The ultraviolet curing adhesive sheet 15 has a main body 15a and a test portion 15b. The main body 15a has a rectangular shape to cover the transparent region S1 of the cover panel 11 from the rear surface. The test portion 15b is a small tab that extends outward from an edge of the main body 15a.

The main body 15a has a rectangular shape similar to the transparent region S1 of the cover panel 11 but dimensions of the main body 15a is slightly larger than that of the transparent region S1. Thus, the main body 15a covers an entire area of the transparent region S1. The test portion 15b extends outward from one of long edges of a peripheral portion 15d of the main body 15a. The test portion 15b is smaller than the main portion 15a and has a size to be arranged within the non-transparent region S2. Although the test portion 15b and the main body 15a continue to each other, a separation line 15c is in a border between the main body 15a and the test portion 15b. The separation line 15c is configured to separate the test portion 15b and the main body 15a. The separation line 15c includes small holes or recesses that are in line along the border (a border line). Namely, the separation line 15c is a perforated line (a broken line form).

The test portion 15b is a portion to be used in a peeling test to check a state of cure of the ultraviolet curing adhesive sheet 15. The ultraviolet curing adhesive sheet 15 is peeled from the light blocking portion 14, which is an adherend, and separated from the main body 15a, accordingly. The test portion 15b is on the light blocking portion 14 that is formed on the rear surface of the cover panel 11. According to this configuration, even if a small piece of the test portion 15b remains on the cover panel 11 (i.e., on the light blocking portion 14), the small piece is less likely to affect the display property of the layered panel (the liquid crystal display device 10).

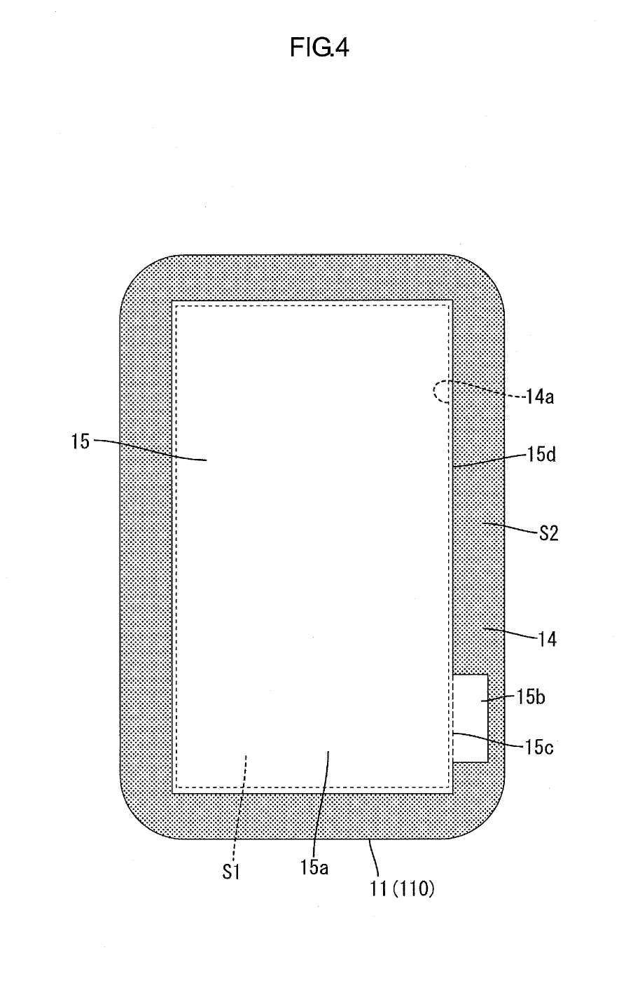

FIG. 4 is an explanatory view of the ultraviolet curing adhesive sheet 15 attached to the cover panel 11. To attach the cover panel 11 and the liquid crystal display panel 12, the ultraviolet curing adhesive sheet 15 is attached to the cover panel 11 (a first attachment process). To attach the ultraviolet curing adhesive sheet 15 of this embodiment to the cover panel 11, it is performed under an atmospheric pressure (at a normal pressure) using a known device to attach sheets.

As illustrated in FIG. 4, the ultraviolet curing adhesive sheet 15 is attached to the rear surface of the cover panel 11 such that the main body 15a covers an entire area of the transparent region S1 and such that the peripheral portion 15d of the main body 15a is placed over an inner peripheral portion 14a of the light blocking portion 14. The test portion 15b of the ultraviolet curing adhesive sheet 15 is attached on the light blocking portion 14 so as to be within the non-transparent region S2. The separation line 15c is located outward with respect to the inner peripheral portion 14a of the light blocking portion (i.e., a border between the transparent region S1 and the non-transparent region S2). That is, the separation line 15c is arranged on the light blocking portion 14.

Since the test portion 15b of the ultraviolet curing adhesive sheet 15 extends from a portion of the peripheral portion 15d of the main body 15, the main body 15 and the test portion 15b can be attached to the adherend (i.e., to the first panel member) together.

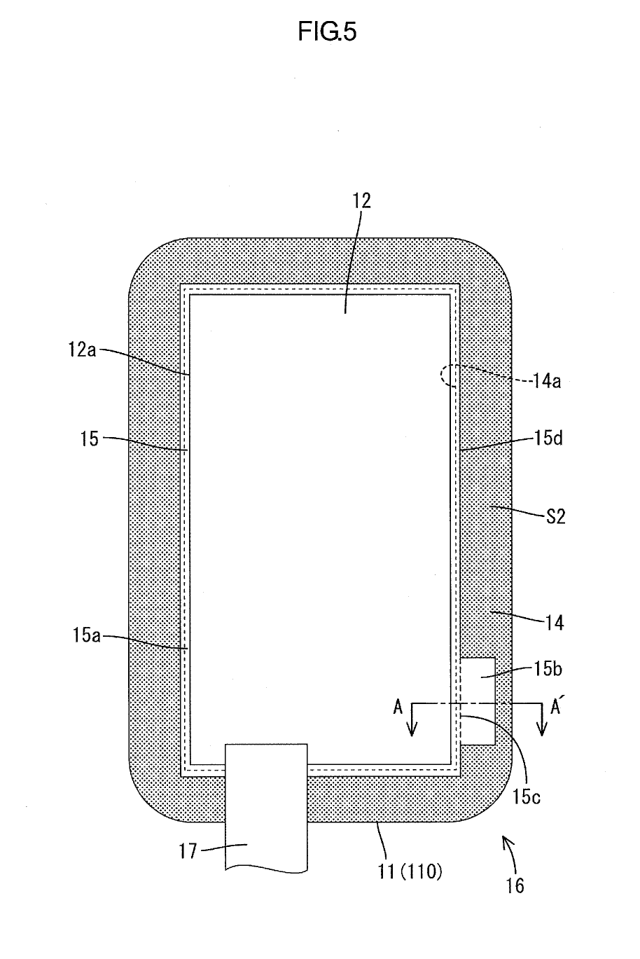

After the ultraviolet curing adhesive sheet 15 is attached to the rear surface of the cover panel 11 as illustrated in FIG. 4, the liquid crystal display panel 12 is attached to the ultraviolet curing adhesive sheet 15 (a second attachment process) as illustrated in FIG. 5. FIG. 5 is a plan view of the layered panel 16 in which a liquid crystal display panel 12 is attached to the ultraviolet curing adhesive sheet 15 that is illustrated in FIG. 4.

As illustrated in FIG. 5, the liquid crystal display panel 12 has a rectangular and vertically long overall shape, similar to the cover panel 11. The liquid crystal display panel 12 has a size that fits within the transparent region S1 (i.e., within the main body 15a of the ultraviolet curing adhesive sheet 15). The liquid crystal display panel 12 includes a pair of transparent substrates (a thin film transistor array substrate and a color filter substrate) and a pair of polarization plates. The substrates sandwich liquid crystals therebetween. The polarizing plates are arranged on outer surfaces of the respective substrates. In this description, the liquid crystal display panel 12 will be described as a single panel member (a second panel member). As illustrated in FIG. 5, a flexible printed circuit board 17 is connected to the liquid crystal display panel 12 for feeding power and control signals to the liquid crystal display panel 12.

The liquid crystal display panel 12 is attached to the ultraviolet curing adhesive sheet 15 such that the display surface of the liquid crystal display panel 12 is in contact with the rear adhesive surface of the ultraviolet curing adhesive sheet 15. The position (alignment) of the liquid crystal display panel 12 on the ultraviolet curing adhesive sheet 15 is finely adjusted as appropriate. Since the ultraviolet curing adhesive sheet 15 is not completely cured, the liquid crystal display panel 12 can be detached from the adhesive surface of the ultraviolet curing adhesive sheet 15 and reattached, or the liquid crystal display panel 12 can be slightly moved on the adhesive surface of the ultraviolet curing adhesive sheet 15. Through the adjustment, the liquid crystal display panel 12 is arranged on the main body 15a of the ultraviolet curing adhesive sheet 15 such that the position of the liquid crystal display panel 12 is within the area of the transparent region S1. That is, a periphery 12a of the liquid crystal display panel 12 is located inward with respect to the inner peripheral portion 14a of the light blocking portion 14. The liquid crystal display panel 12 may be attached to the ultraviolet curing adhesive sheet 15 on the cover panel 11 by a known vacuum bonding device.

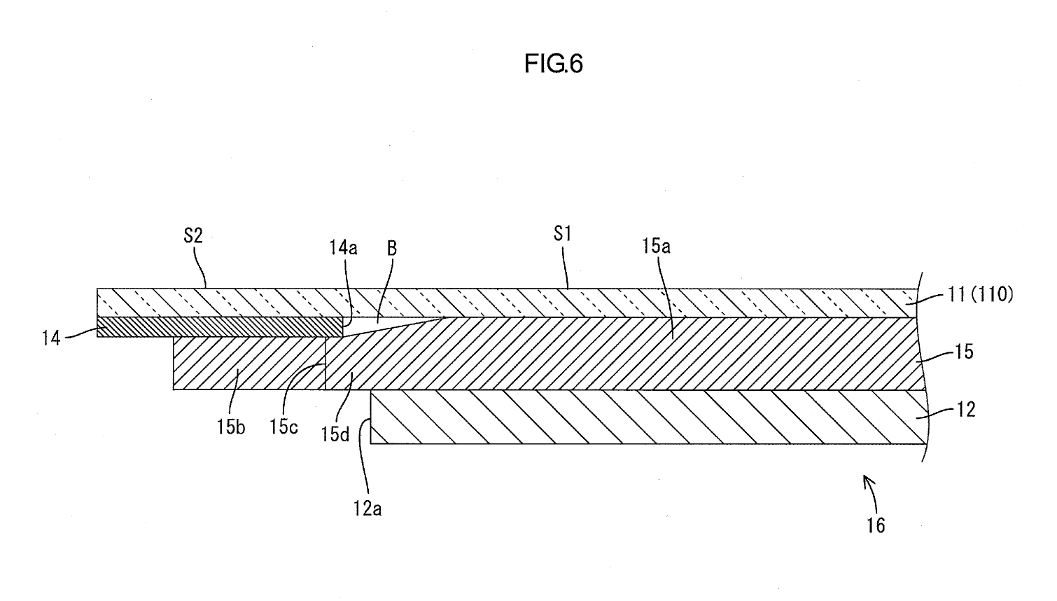

FIG. 6 is a cross-sectional view cut along line A-A′ in FIG. 5 and schematically illustrates a cross-sectional structure of a portion of the layered panel 16 near the test portion 15b. In the layered panel 16 illustrated in FIG. 6, the ultraviolet curing adhesive sheet 15 is not cured yet and thus has a certain level of flexibility. However, even with the flexibility, a gap (bubble) B may be created between the peripheral portion 15d of the main body 15a of the ultraviolet curing adhesive sheet 15 and the cover panel 11, as illustrated in FIG. 6. The gap B is created because the light blocking portion 14 forms a step that is raised from the rear surface of the cover panel 11 and the peripheral portion 15d of the main body 15a is placed on the light blocking portion 14. That is, even with the ultraviolet curing adhesive sheet 15 that is in the uncured state, the uncured ultraviolet curing adhesive sheet 15 does not follow the shape of the light blocking portion 14 (in particular, the shape of the inner peripheral portion 14a). In other cases, the gap (bubble) B may be created due to residual stress in the ultraviolet curing adhesive sheet 15, or differences in coefficient of thermal expansion between the ultraviolet curing adhesive sheet 15 and the cover panel 11.

The gap (bubble) B illustrated in FIG. 6 may become a factor to degrade the display quality of the liquid crystal display device 10. Thus, it is preferred that the gap (bubble) B is not created in the layered panel 16. To reduce the gap (bubble) B, a heating treatment is performed for the layered panel 16 that includes the uncured ultraviolet curing adhesive sheet 15. Conditions of the heating treatment are appropriately determined based on the size of the layered panel 16, which is a subject to be heated, and materials used in the layered panel 16. The layered panel 16 according to this embodiment is heated at 60° C. for 30 minutes using a known heating treatment device.

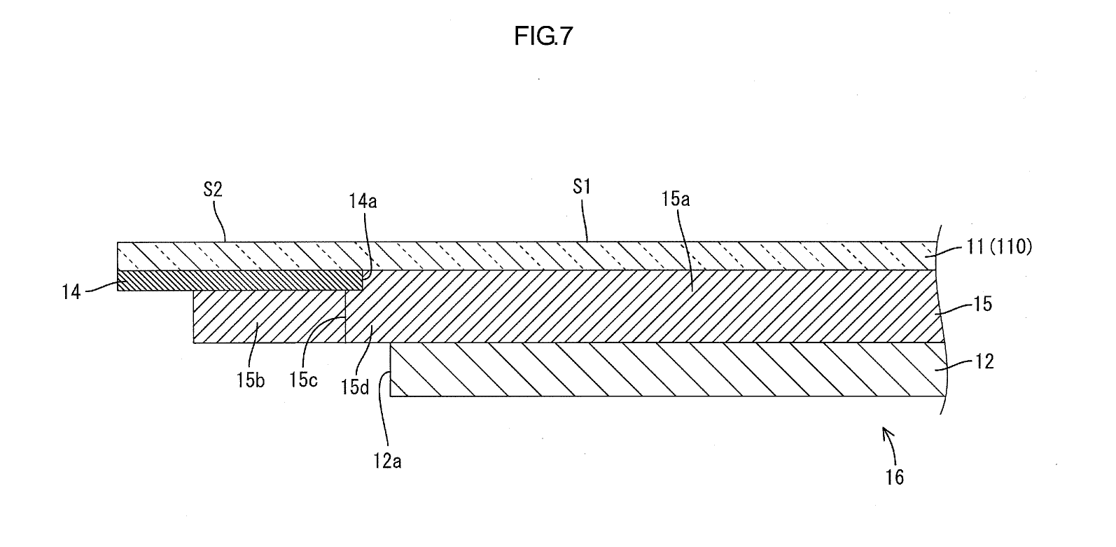

After the heating treatment, the layered panel 16 is left under a high pressure condition using an autoclave. Specifically, an autoclave treatment is applied to the heated layered panel 16 under a pressure of 5 atmospheres for 30 minutes. Through this treatment, as illustrated in FIG. 7, the gap (bubble) B in the layered panel 16 disappears or the size thereof is reduced to a smaller one that does not affect the display quality. FIG. 7 is a cross-sectional view of the layered panel 16 after the autoclave treatment is performed.

Since the uncured ultraviolet curing adhesive sheet 15 has thermal flexibility, when heat is applied, the ultraviolet curing adhesive sheet 15 softens and changes the shape along the shape of the cover panel 11 and the light blocking portion 14. Furthermore, through the autoclave treatment, gas in the gap (bubble) B between the adhesive surface of the ultraviolet curing adhesive sheet 15 and the cover panel 11 and the light blocking portion 14 is properly released.

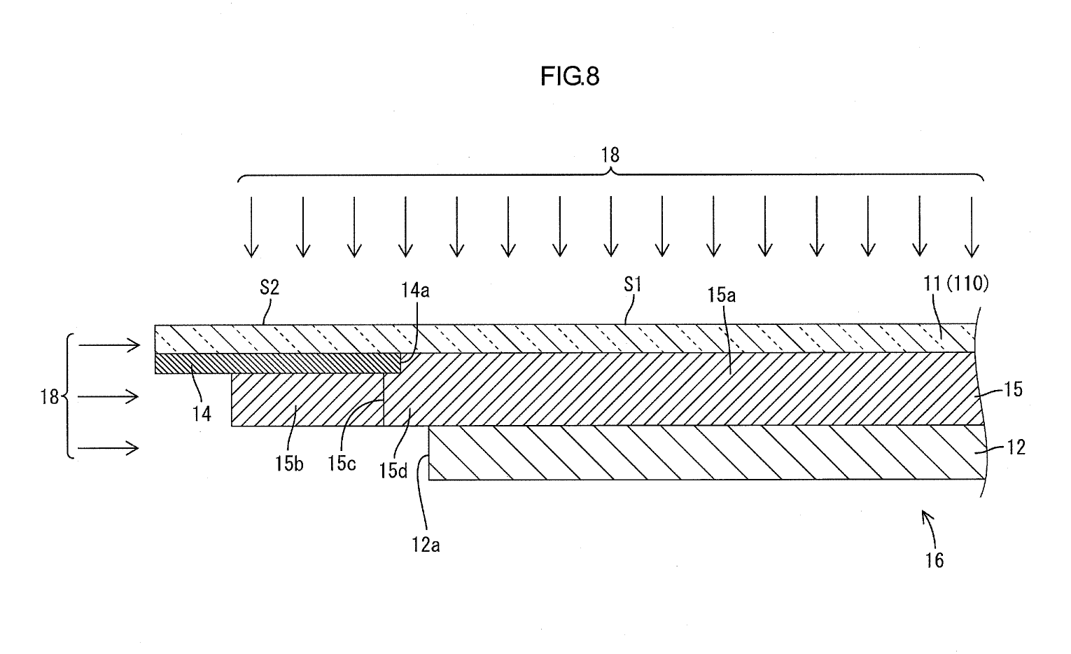

After the gap (bubble) B in the layered panel 16 is removed, ultraviolet rays are applied to the uncured ultraviolet curing adhesive sheet 15 to cure (an applying process). FIG. 8 is an explanatory view of the layered panel 16 illustrating a process of applying ultraviolet rays 18 to the layered panel 16 to cure the ultraviolet curing adhesive sheet 15.

Ultraviolet rays are applied to the ultraviolet curing adhesive sheet 15 of the layered panel 16 using a known device for applying ultraviolet rays. Ultraviolet rays 18 are applied to a front surface of the layered panel 16 (i.e., a front surface of the cover panel 11) and peripheral surfaces of the layered panel 16. When the ultraviolet rays 18 are applied to the front surface of the layered panel 16, the ultraviolet rays 18 pass through the cover panel 11 and reach a large area of the main body 15a of the ultraviolet curing adhesive sheet 15. In response to the applied ultraviolet rays, a curing reaction develops and thus the ultraviolet curing adhesive sheet 15 cures.

Since the main body 15 is arranged such that the peripheral portion 15d thereof is on the light blocking portion 14, the peripheral portion 15d of the main body 15 is behind the light blocking portion 14 (the non-transparent region S2) when the layered panel 16 is seen from the front. Namely, the peripheral portion 15d of the main body 15a may not be sufficiently cured by the ultraviolet rays 18 that are applied to the front surface of the layered panel 16. Therefore, the ultraviolet rays 18 are applied to the peripheral surfaces (side surfaces) of the layered panel 16. When the ultraviolet rays 18 are applied to the peripheral surfaces of the layered panel 16, the ultraviolet rays 18 properly reach throughout the peripheral portion 15d of the main body 15. As a result, the entire area of the ultraviolet curing adhesive sheet 15 cures.

Similar to the peripheral portion 15d of the main body 15a, the test portion 15b of the ultraviolet curing adhesive sheet 15 is behind the light blocking portion 14 (the non-transparent region S2) when the layered panel 16 is seen from the front. Therefore, the test portion 15b is basically cured by the ultraviolet rays 18 that are applied to the peripheral surfaces (side surfaces) of the layered panel 16.

An adhesive property and a coefficient of elasticity of the ultraviolet curing adhesive sheet 15 vary significantly in the uncured state and a cured state, namely, before the ultraviolet rays 18 are applied and after the ultraviolet rays 18 are applied. The adhesive property of the ultraviolet curing adhesive sheet 15 (rigidity against a glass during a peeling test) is 10 (N/25 mm) before the ultraviolet rays 18 are applied, whereas the adhesive property of the ultraviolet curing adhesive sheet 15 (rigidity against a glass during a peeling test) is 25 (N/25 mm) after the ultraviolet rays 18 are applied. The coefficient of elasticity of the ultraviolet curing adhesive sheet 15 (Pa) before the ultraviolet rays 18 are applied is 104 (Pa), whereas the coefficient of elasticity of the ultraviolet curing adhesive sheet 15 after the ultraviolet rays 18 are applied is 105 (Pa).

In production of the layered panel 16, whether the ultraviolet rays 18 are properly applied to the ultraviolet curing adhesive sheet 15 (the state of curing of the ultraviolet curing adhesive sheet 15) is checked by the peeling test performed on the test portion 15b, which is a portion of the ultraviolet curing adhesive sheet 15. The test portion 15b is not a necessary portion to bond the panels so that peeling off the test portion 15b does not cause any problems.

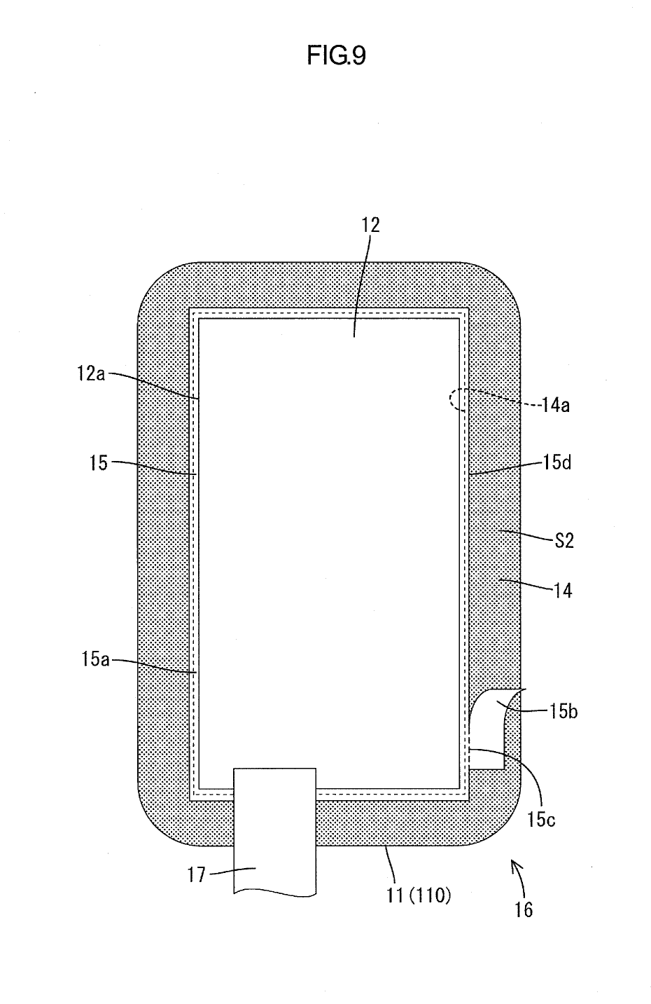

FIG. 9 is an explanatory view of the layered panel 16 illustrating how a peeling test is performed (a peeling process). As illustrated in FIG. 9, the test portion 15b on the light blocking portion 14 is peeled from an edge of the test portion 15b (the peeling process). In the peeling test, the test portion 15b is peeled (removed) from the light blocking portion 14 while being separated from the main body 15a along the separation line 15c, which is configured as the border.

One of the methods of checking the state of cure of the ultraviolet curing adhesive sheet 15 is to measure a resistance (hereinafter, referred to as a peeling force) of the test portion 15b while the test portion 15b is being peeled from the light blocking portion 14, which is the adherend. Then, the peeling force is compared to a peeling force of the test portion 15b in a cured state measured in advance, or compared to a peeling force of the test portion 15b in an uncured state measured in advance.

If the measured peeling force of the test portion 15b is equal to the peeling force of the test portion 15b in the cured state measured in advance, the ultraviolet curing adhesive sheet 15 is properly cured. If the measured peeling force of the test portion 15b is smaller than the peeling force of the test portion 15b in the cured state measured in advance, the ultraviolet curing adhesive sheet 15 is not properly cured.

If the measured peeling force of the test portion 15b is larger than the peeling force of the test portion 15b in the uncured state measured in advance, the curing reaction of the ultraviolet curing adhesive sheet 15 is in progress in response to the applied ultraviolet rays. If the measured peeling force of the test portion 15b is equal to the peeling force of the test portion 15b in the uncured state measured in advance, the ultraviolet curing adhesive sheet 15 is not properly cured.

The state of cure of the ultraviolet curing adhesive sheet 15 may be checked by comparing the peeling forces as described above or by comparing the coefficients of elasticity of the ultraviolet curing adhesive sheet 15. The coefficient of elasticity of the ultraviolet curing adhesive sheet 15 is calculated from the peeling force and the area of the test portion 15b.

Another method of checking the state of cure of the ultraviolet curing adhesive sheet 15 is to qualitatively check the state of cure of the ultraviolet curing adhesive sheet 15 through a visual observation. If the test portion 15b is in the uncured state, the test portion 15b stretches greater than the test portion 15b in the cured state when the test portion 15b is being peeled from the light blocking portion 14 and separated from the main body 15a. Namely, by visually observing a degree of stretch in the test portion 15b when the test portion 15b is being peeled, the state of cure of the ultraviolet curing adhesive sheet 15 is approximately checked. Through the method of visual checking, whether the ultraviolet curing adhesive sheet 15 is uncured is easily checked.

If the ultraviolet curing adhesive sheet 15 is judged to be in the uncured state (not properly cured), the layered panel 16 including the ultraviolet curing adhesive sheet 15 is judged as a defective and separated from a non-defective item, that is, the ultraviolet curing adhesive sheet 15 that is in the cured state (properly cured). Thus, the layered panel 16 judged as a defective is less likely to set in the liquid crystal display device 10 at least as the ultraviolet curing adhesive sheet 15 is in the uncured state.

The layered panel 16 judged as a defective as described above may be exposed to ultraviolet rays to properly cure the ultraviolet curing adhesive sheet 15.

One of the reasons that the ultraviolet curing adhesive sheet 15 is judged to be in the uncured state, in the method of checking the state of cure, is that ultraviolet rays have not been applied to the ultraviolet curing adhesive sheet 15 because of a breakdown of a device for applying ultraviolet rays to the ultraviolet curing adhesive sheet 15.

The layered panel 16 that is judged as a non-defective item goes through several production processes and sets in the liquid crystal display device 10.

The method of manufacturing the layered panel 16 includes a first attachment process, a second attachment process, an applying process, a peeling process, and a checking process. In the first attachment process, the adhesive sheet 15 is attached to the first panel member 110. The first panel member 110 includes the cover panel 11 through which rays of light pass and the light blocking portion 14 blocking rays of light and having a frame-like shape and located on the peripheral portion of the one of the plate surfaces of the cover panel 11. The adhesive sheet 15 is a transparent sheet made of ultraviolet curing adhesive and configured to cure when ultraviolet rays are applied. The adhesive sheet 15 includes the main body 15a and the test portion 15b. The main body 15a is for covering the portion of the plate surface of the first panel member 110 that is on the inner side with respect to the light blocking portion 14. The test portion 15b extends outward from the periphery of the main body 15a and disposed on the light blocking portion 14. In the first attachment process, one of surfaces of the adhesive sheet 15 is attached to the one surface of the cover panel 11 of the first panel member 110 with adhesive in an uncured state. In the second attachment process, one of the plate surfaces of the second panel member 12 is attached to another one of the surfaces of the adhesive sheet 15 in the uncured state such that the test portion 15b is projected outward from the periphery of the liquid crystal display panel 12 configured as the second panel member 12, and such that the main body 15a is sandwiched between the second panel member 12 and the first panel member 110. In the applying process, ultraviolet rays are applied to the adhesive sheet 15 that is sandwiched between the first panel member 110 and the second panel member 12. In the peeling process, the test portion 15b is peeled from the light blocking portion 14 while being separated from the main body 15a. In the checking process, a state of cure of the adhesive sheet 15 is checked based on a state of the test portion 15 while the test portion 15a is being peeled.

According to the method of manufacturing the layered panel 16 of this embodiment, in the checking process, the state of cure of the adhesive sheet 15 is easily checked based on the state of the test portion 15b while the test portion 15b is being peeled.

In the method of manufacturing the layered panel 16 according to this embodiment, the peeling process includes measuring a peeling force of the test portion 15b while the test portion 15b is being peeled, and the checking process includes checking the state of cure of the adhesive sheet 15 based on a result of the measuring of the peeling force of the test portion 15b. According to the method of manufacturing the layered panel 16 of this embodiment, the state of the test portion 15b while the test portion 15b is being peeled can be qualitatively grasped from the peeling force measured in the peeling process. Therefore, the state of cure of the adhesive sheet 15 is accurately checked.

In the method of manufacturing the layered panel 16 according to this embodiment, the adhesive sheet includes the separation line 15c along the border between the main body 15a and the test portion 15b. The separation line 15c is configured as a line to assist separation of the test portion 15b from the main body 15. In the peeling process, the test portion 15b is separated from the main body along the separation line 15c. In the method of manufacturing the layered panel 16, the test portion 15b is properly separated from the main body 15a. That is, the main body 15 is less likely to crack while the test portion 15b is being peeled and thus the main body 15 is less likely to be damaged. Furthermore, the test portion is less likely to be separated from the main body 15a such that a portion of the test portion 15b remains with the main body 15a. Thus, peeling failure is less likely to occur. If a crack occurs in the main portion 15a when the test portion 15b is being peeled and thus the main body 15a is damaged, the damage results in a factor that causes a display defect in the liquid crystal display device 10. If the test portion 15b is separated from the main portion 15a such that a portion of the test portion 15b remains with the main body 15a, the portion that remains with the main portion 15a may contact other components when the layered panel 16 is set in the liquid crystal display device 10. Thus, the position of the layered panel 16 may be displaced from a correct portion. If the position of the layered panel 16 is displaced, the quality of the display of the liquid crystal display device 10 is degraded.

In method of checking a state of cure of the adhesive sheet 15 of the layered panel 16, the layered panel 16 includes the first panel member 110, the second panel member 12, and the adhesive sheet 15, and the method includes the peeling process and the checking process. The first panel member 110 includes the cover panel 11 through which rays of light pass and the light blocking portion 14 for blocking rays of light. The light blocking portion 14 is a layer having a frame-like shape and located on the peripheral portion of one of plate surfaces of the cover panel 11. The second panel member 12 is the liquid crystal display panel 12. The adhesive sheet 15 is a transparent sheet made of ultraviolet curing adhesive and configured to cure when ultraviolet rays are applied. The adhesive sheet 15 covers the portion of one of the plate surfaces of the first panel member 11 exposed at the inner side with respect to the light blocking portion 14. The adhesive sheet 15 is sandwiched between the first panel member 110 and the second panel member 12 for attaching the first panel member 110 and the second panel member 12. The adhesive sheet 15 includes the main body 15a and the test portion 15b. The main body 15a covers the portion of the one of the plate surfaces of the first panel member 110 that is on an inner side with respect to the light blocking portion 14. The test portion 15b extends outward from the periphery of the main body 15a and is on the light blocking portion 14 such that the test portion 15b is projected outward from the periphery of the second panel 12. In the peeling process, the test portion 15b is peeled from the light blocking portion 14 while being separated from the main body 15a. In the checking process, the state of cure of the adhesive sheet 15 is checked based on a state of the adhesive sheet 15 while the test portion 15b is being peeled.

According to the method of checking the state of cure, based on the state of the test portion 15b while the test portion 15b is being peeled, the state of cure of the adhesive sheet 15 is easily checked.

In the method of checking the state of cure, when the test portion 15b is being peeled, a peeling force of the test portion 15b is measured. Based on a result of the measurement of the peeling force of the test portion 15b, the state of cure of the adhesive sheet 15 is accurately checked. According to the method of checking the state of cure, the state of the test portion 15b is qualitatively grasped by measuring the peeling force of the test portion 15b while the test portion 15b is being peeled. Therefore, the state of cure of the adhesive sheet 15 is accurately checked.

In the method of checking the state of cure, the adhesive sheet 15 includes the separation line 15c in the border between the main body 15a and the test portion 15b. The separation line 15c is configured to assist separation of the test portion 15b from the main body 15a. The test portion 15b is peeled from the light blocking portion 14 while being separated from the main body 15a along the separation line 15c. In the method of checking the layered panel 16, the test portion 15b is properly separated from the main body 15a. That is, the main body 15 is less likely to crack while the test portion 15b is being peeled and thus the main body 15 is less likely to be damaged. Furthermore, the test portion is less likely to be separated from the main body 15a such that a portion of the test portion 15b remains with the main body 15a. Thus, peeling failure is less likely to occur. If a crack occurs in the main portion 15a when the test portion 15b is being peeled and thus the main body 15a is damaged, the damage results in a factor that causes a display defect in the liquid crystal display device 10. If the test portion 15b is separated from the main portion 15a with a portion of the test portion 15b remains with the main body 15a, the portion that remains with the main portion 15a may contact other components when the layered panel 16 is set in the liquid crystal display device 10. Thus, the position of the layered panel 16 may be displaced from a correct portion. If the position of the layered panel 16 is displaced, the quality of the display of the liquid crystal display device 10 is degraded.

### Second Embodiment

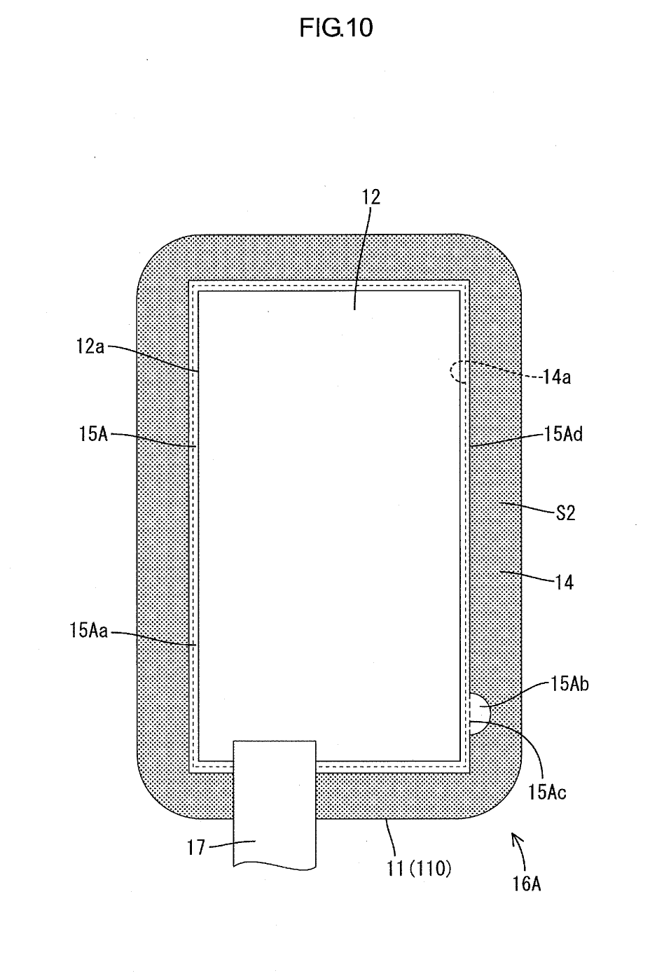

A second embodiment will be described with reference to FIG. 10. Portions same as those in the first embodiment are provided with the same symbols or numerals as those in the first embodiment and will not be described.

FIG. 10 is a plan view of a layered panel 16A according to a second embodiment. Configurations of the layered panel 16A according to this embodiment are basically similar to those of the first embodiment. In particular, a main body 15Aa of an ultraviolet curing adhesive sheet 15A included in the layered panel 16A according to this embodiment is similar to the first embodiment but a test portion 15Ab of the ultraviolet curing adhesive sheet 15A is different in shape from that in the first embodiment. Specifically, the test portion 15Ab has a semi-spherical shape.

The semi-spherical test portion 15Ab includes a portion corresponding to a “chord” and a portion corresponding to an “arc.” The test portion 15Ab is continuous with the main body 15Aa such that the portion corresponding to a “chord” is adjacent to the main body 15Aa and the portion corresponding to an “arc” is located outward. A separation line 15Ac, similar to the first embodiment, is in a border between the main body 15Aa and the test portion 15Ab.

Such as included in this embodiment, the ultraviolet curing adhesive sheet 15A that includes the semi-spherical test portion 15Ab may be used.

### Third Embodiment

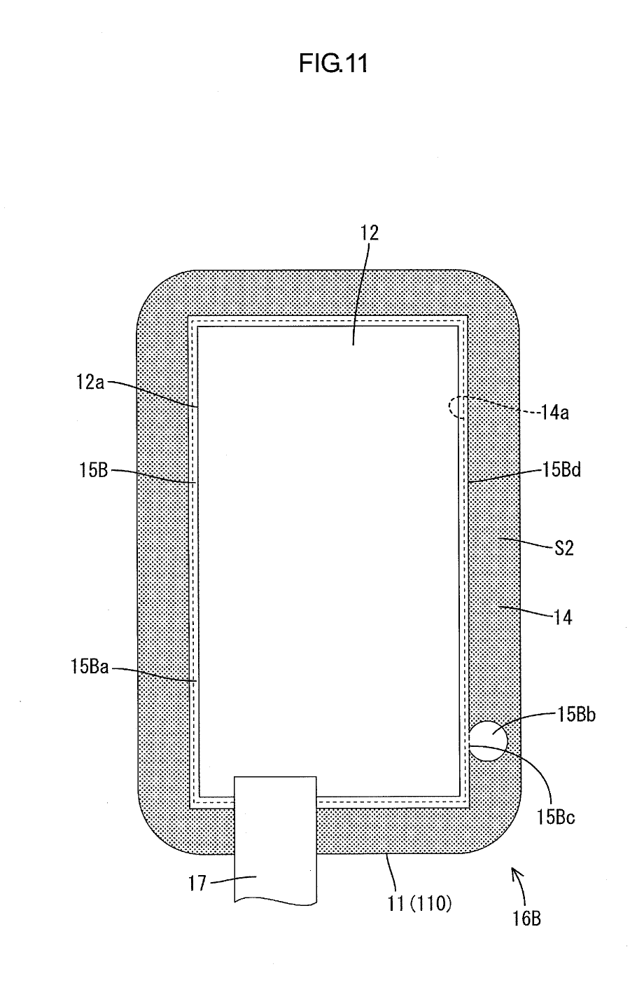

A third embodiment will be described with reference to FIG. 11. FIG. 11 is a plan view of a layered panel 16B according to this embodiment. Configurations of the layered panel 16B according to this embodiment are basically similar to the first embodiment. Specifically, a main body 15Ba of an ultraviolet curing adhesive sheet 15B included in the layered panel 16B is similar to the first embodiment but the shape of a test portion 15Bb of the ultraviolet curing adhesive sheet 15B of this embodiment is different from the first embodiment. In particular, the test portion 15Bb has a substantially circular shape.

The circular test portion 15Bb is continuous with the main body 15Ba with a portion of a periphery of the circular shape adjacent to the main body 15Ba. The test portion 15Bb includes a continuing portion that is continuous with the main body 15Ba (i.e., a border portion between the test portion Bb and the main body 15Ba) and an outer portion located outward with respect to the continuing portion. The continuing portion is narrower than the outer portion. A separation line 15Bc, similar to the first embodiment, is in a border between the main body 15Ba and the test portion 15Bb.

Such as used in this embodiment, the ultraviolet curing adhesive sheet 15B that includes the circular test portion 15Bb may be used. Since the continuing portion is continuous with the main body 15Ba (the border portion between the test portion 15Bb and the main body 15Ba) and narrower than that of the outer portion of the test portion 15Bb, the test portion 15Bb is easily separated from the main body 15Ba.

### Fourth Embodiment

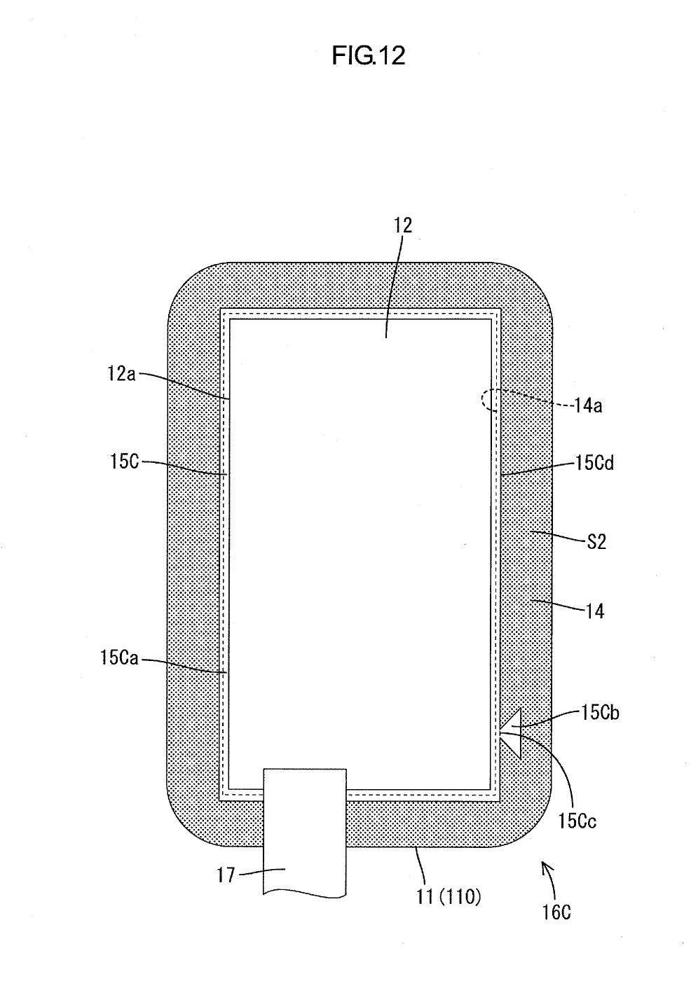

A fourth embodiment will be described with reference to FIG. 12. FIG. 12 is a plan view of a layered panel 16C. Configurations of the layered panel 16C according to this embodiment are basically similar to the first embodiment. Specifically, a main body 15Ca of an ultraviolet curing adhesive sheet 15C included in the layered panel 16C is similar to the first embodiment but the shape of a test portion 15Cb of this embodiment is different from the first embodiment. In particular, the test portion 15Cb has a substantially triangular shape.

The triangular test portion 15Cb is continuous with the main body 15Ca such that one of apex portions of the triangular is adjacent to the main body 15Ca. The test portion 15Cb includes a continuing portion that is continuous with the main body 15Ca (a border portion between the test portion 15Cb and the main body 15Ca) and an outer portion located outward with respect to the continuing portion. The continuing portion is narrower than that of the outer portion. A separation line 15Cc, similar to the first embodiment, is in a border between the main body 15Ca and the test portion 15Cb.

Such as included in this embodiment, the ultraviolet curing adhesive sheet 15C that includes the test portion 15Cb having a rectangular shape may be used. In this embodiment, since the continuing portion is continuous with the main body 15Ca (the border portion between the test portion 15Cb and the main body 15Ca) and narrower than the outer portion, the test portion 15Cb is easily separated from the main body 15Ca.

### Fifth Embodiment

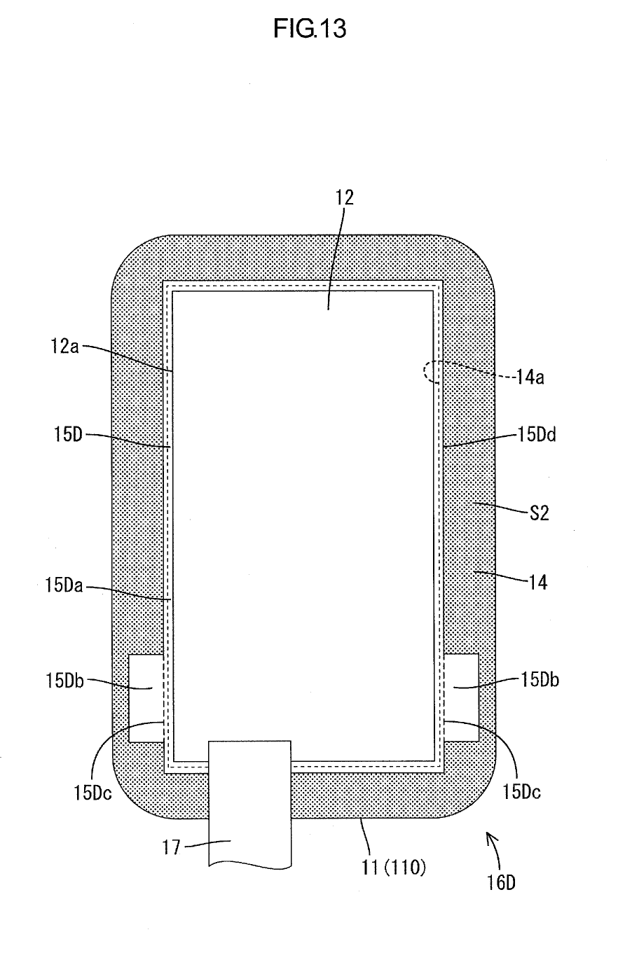

A fifth embodiment will be described with referent to FIG. 13. FIG. 13 is a plan view of a layered panel 16D. Configurations of the layered panel 16D according to this embodiment are basically similar to the first embodiment. However, in the layered panel 16D according to this embodiment, an ultraviolet curing adhesive sheet 15D includes two test portions 15Db for a single main body 15a. The main body 15Da of this embodiment is similar to that of the first embodiment. That is, the ultraviolet curing adhesive sheet 15D of this embodiment has a configuration similar to a configuration of the ultraviolet curing adhesive sheet 15 of the first embodiment with another test portion 15Db added thereto.

Similar to the first embodiment, the test portions 15Db have a rectangular shape. The test portion 15Db is continuous with the main body 15Da such that one of long edges of the each test portion 15Db is adjacent to the main body 15Da. Separation lines 15Dc, which are similar to the one in the first embodiment, are in borders between the main body 15Da and the respective test portions 15Db. The two test portions 15Db that are continuous with the main body 15Da are opposite to each other with the main body 15Da therebetween.

Such as used in this embodiment, the ultraviolet curing adhesive sheet 15D that includes multiple test portions 15Db may be used. In this embodiment, since the ultraviolet curing adhesive sheet 15D includes multiple test portions 15Db, removing tests (peeling test) in which the test portions 15Db are peeled from the light blocking portion 14 can be performed several times. If the state of cure is judged as insufficient in the peeling test after ultraviolet rays are applied, ultraviolet rays are applied again and the peeling test can be performed. Furthermore, based on results of the peeling tests that have been performed multiple times (such as the average of the peeling forces), the state of cure of the adhesive sheet can be accurately grasped.

### OTHER EMBODIMENTS

The present invention is not limited to the embodiments described in the above description and the drawings. The following embodiments may be included in the technical scope of the present invention.

(1) In the above embodiments, the second panel member attached to the first panel member via the ultraviolet curing adhesive sheet 15 is a liquid crystal display panel. However, an example of the present invention is not limited to such an example. The second panel member may be a touch panel.

(2) In the above embodiments, when the test portion is peeled from the light blocking portion that is the adherend, angles at which the test portion is peeled are not limited; however, the test portion may be peeled at an angle of 90° or 180°. That is, by peeling the test portion through a technique similar to a commonly known peeling test, the state of cure of the adhesive sheet may be grasped.

### EXPLANATION OF SYMBOLS

10: liquid crystal display device, 11: cover panel, 12: liquid crystal display panel (second panel member), 12a: peripheral portion of the liquid crystal display panel, 13: casing, 14: light blocking portion, 14a: inner peripheral portion of the light blocking portion, 15: ultraviolet curing adhesive sheet (adhesive sheet), 15a: main body, 15b: test portion, 15c: separation line, 15d: peripheral portion, 16: layered panel, 17: flexible printed circuit board, 18: ultraviolet ray, 110: first panel member, s1: transparent region, s2: non-transparent region, b: gap (bubble).

1. A method of manufacturing a layered panel, the method comprising steps of:
performing a first attachment process to attach an adhesive sheet to a first panel member, the first panel member including a panel through which rays of light pass and a light blocking portion blocking rays of light and having a frame-like shape and located on a peripheral edge portion of one plate surface of the panel, the adhesive sheet being a transparent sheet made of ultraviolet curing adhesive and configured to cure when ultraviolet rays are applied, the adhesive sheet including a main body and a test portion, the main body for covering a portion of the one plate surface of the first panel member that is on an inner side with respect to the light blocking portion, the test portion extending outward from a periphery of the main body and disposed on the light blocking portion, in the first attachment process, attaching one of surfaces of the adhesive sheet to the one plate surface of the panel of the first panel member with the adhesive sheet in an uncured state;
performing a second attachment process to attach one of plate surfaces of a second panel member to another one of the surfaces of the adhesive sheet in the uncured state such that the test portion is projected outward from a periphery of the second panel member, and such that the main body is sandwiched between the second panel member and the first panel member;
applying ultraviolet rays to the adhesive sheet sandwiched between the first panel member and the second panel member;
peeling the test portion from the light blocking portion while separating the test portion from the main body; and
checking a state of cure of the adhesive sheet based on a state of the test portion while being peeled.

2. The method of manufacturing a layered panel according to claim 1, wherein
the peeling step includes measuring a peeling force of the test portion while the test portion is being peeled, and
the checking step includes checking the state of cure of the adhesive sheet based on a result of the measuring of the peeling force of the test portion.

3. The method of manufacturing a layered panel according to claim 1, wherein
the adhesive sheet includes a separation line along a border between the main body and the test portion, the separation line is configured to assist separation of the test portion from the main body, and
in the peeling step, the test portion is separated from the main body along the separation line.

4. The method of manufacturing a layered panel according to claim 1, wherein the test portion includes a continuing portion and an outer portion, the continuing portion being continuous with the main body, the outer portion being outward with respect to the continuing portion, the continuing portion being narrower than the outer portion.

5. The method of manufacturing a layered panel according to claim 1, wherein the test portion includes no less than two test portions.

6. The method of manufacturing a layered panel according to claim 1, wherein the second panel member is a liquid crystal display panel.

7. The method of manufacturing a layered panel according to claim 1, wherein the second panel member includes a touch panel.

8. A method of checking a state of cure of an adhesive sheet of a layered panel, the layered panel including:
a first panel member that includes a panel through which rays of light pass and a light blocking portion for blocking rays of light, the light blocking portion being a layer having a frame-like shape and located on a peripheral portion of one of plate surfaces of the panel;
a second panel member; and
an adhesive sheet being a transparent sheet made of ultraviolet curing adhesive and configured to cure when ultraviolet rays are applied, the adhesive sheet covering a portion of the one of the plate surfaces of the first panel member that is on an inner side with respect to the light blocking portion, the adhesive sheet being sandwiched between the first panel member and the second panel member for attaching the first panel member and the second panel member, the method comprising steps of:
peeling a test portion of the adhesive sheet therefrom, the adhesive sheet including a main body and the test portion, the main body covering the portion of the one of the plate surfaces of the first panel member that is on the inner side with respect to the light blocking portion, the test portion extending outward from a periphery of the main body and being on the light blocking portion such that the test portion is projected outward from a periphery of the second panel member, peeling step including peeling the test portion from the light blocking portion while separating the test portion from the main body; and
checking the state of cure of the adhesive sheet based on a state of the adhesive sheet in the peeling step.

9. The method of checking a state of cure of an adhesive sheet according to claim 8, further comprising:
measuring a peeling force of the test portion while the test portion is being peeled from the light blocking portion; and
checking the state of cure of the adhesive sheet based on a result of the measurement of the peeling force of the test portion.

10. The method of checking a state of cure of an adhesive sheet according to claim 8, wherein
the adhesive sheet includes a separation line along a border between the main body and the test portion and configured to assist separation of the test portion from the main body, and
when the test portion is peeled from the light blocking portion, the test portion is separated from the main body along the separation line.
